(19) United States
(12) Patent Application Publication
(10) Pub. No.: US 2013/0221108 A1
(43) Pub. Date: Aug. 29, 2013

(54) OPTICALLY-READABLE ELECTROMAGNETIC ANTENNA

(71) Applicant: Ronald Steven Cok, Rochester, NY (US)

(72) Inventor: Ronald Steven Cok, Rochester, NY (US)

(21) Appl. No.: 13/407,058

(22) Filed: Feb. 28, 2012

(51) Int. Cl. G06K 19/077

(52) U.S. Cl. 235/492

(57) ABSTRACT

An optically-readable electromagnetic antenna for an electronic device includes a substrate having a selected antenna region. A first conductive element having a first color is disposed over the substrate in a first portion of the selected antenna region. A second conductive element having a second color different from the first color is disposed over the substrate in a second portion of the selected antenna region. The second portion abuts the first portion so that the first and the second conductive elements are electrically connected. A feed line electrically connects the first or the second conductive element to the electronic device. The first and the second portions together define an optically-readable pattern.

### FIELD OF THE INVENTION

This invention pertains to the field of communications and more particularly to communicating information optically and electromagnetically.

### BACKGROUND OF THE INVENTION

Since 1974, barcodes have been used to attach machine-readable data to physical items. Although barcodes are robust and readily recognizable, they hold a limited amount of data. Moreover, they cannot be read when obscured. Accordingly, radio frequency identification (RFID) is now being used to communicate with low-power electronic devices. Standardized RFID technology provides communication between an interrogator (or “reader”) and a “tag” (or “transponder”), a portable device that transmits an information code or other information to the reader. Tags are generally much lower-cost than readers. Although the term “reader” is commonly used to describe interrogators, “readers” (i.e., interrogators) can also write data to tags and issue commands to tags. For example, a reader can issue a “kill command” to cause a tag to render itself permanently inoperative. Using an RFID tag attached to an instance of a product, e.g., a single boxed item at point of sale, machine-readable data can be carried with the item and accessed even if the RFID tag is not directly facing the reader (provided the item itself does not interfere with the RF signal).

RFID tags and their antennas are generally applied to the exterior of a package. As a result, they occupy space on the package which would otherwise be usable for information or marketing content readable by humans, or barcodes. Moreover, some retail locations are not equipped with RFID readers, so barcodes continue to be required on goods for sale. In non-retail contexts, such as manufacturing, RF-attenuating items can interfere with tag reading, so a barcode can be a useful backup to an RFID tag.

Various schemes have been described to combine the functions of a barcode or other optical information with an RFID tag. U.S. Pat. No. 7,116,222 to Sills et al. describes a magnetic tag including an optical part and a magnetic part. However, the magnetic part requires a custom reader and is not compatible with EPCglobal standard RFID readers. U.S. Patent Publication No. 2011/068177 by Harris describes an RFID tag placed within a barcode to record information about how often the barcode is scanned. However, the tag can be separated from the barcode accidentally, e.g., by abrasion during handling, or deliberately. U.S. Patent Publication No. 2006/232413 by Lam et al. describes an antenna shaped like a barcode. However, any RFID tags to be read by a particular reader are required to have barcodes covering the same area. Moreover, a longer antenna element is required to protrude beyond the barcode to set the resonant frequency, taking up more space. Lam et al. also describe antennas shaped like corporate logos. However, this scheme is only effective for logos that have long, thin features, similar to a meander antenna.

There is, therefore, a continuing need for a way of providing a barcode or other optically-readable information and an antenna, e.g., an RFID tag antenna, while saving space on a package and without restricting the form of the barcode or antenna.

### SUMMARY OF THE INVENTION

According to an aspect of the present invention, there is provided an optically-readable electromagnetic antenna for an electronic device, the antenna comprising:

a) a substrate having a selected antenna region;

b) a first conductive element having a first color disposed over the substrate in a first portion of the selected antenna region;

c) a second conductive element having a second color different from the first color and disposed over the substrate in a second portion of the selected antenna region, the second portion abutting the first portion so that the first and the second conductive elements are electrically connected; and

d) a feed line electrically connecting the first or the second conductive element to the electronic device;

e) wherein the first and the second portions together define an optically-readable pattern.

According to another aspect of the present invention, there is provided a radio-frequency identification (RFID) system, comprising:

a) an antenna according to claim 1, wherein the optically-readable pattern encodes a first data stream; and

b) an RFID tag coupled to the feed line of the antenna, the tag adapted to transmit an electromagnetic signal using the antenna.

According to another aspect of the present invention, there is provided an optically-readable electromagnetic antenna for an electronic device, the antenna comprising:

a) a substrate having a selected antenna region;

b) a first conductive element having a first color disposed over the substrate in a first portion of the selected antenna region;

c) a second conductive element having a second color different from the first color and disposed over the substrate in a second portion of the selected antenna region, the second portion at least partially overlapping the first portion so that the first and second conductive elements are electrically connected; and

d) a feed line electrically connecting the first or second conductive element to the electronic device;

e) wherein the first and second portions together define an optically-readable pattern.

An advantage of this invention is that the optically-readable information and the antenna overlay each other, saving space on a package. The optically-readable information and the antenna are physically integrated so that they cannot be readily dissociated. The form of the antenna and the form of the barcode do not restrict each other. 2-D barcodes with complex interlocking patterns of light and dark can be used, and still provide consistent, easy-to-simulate RF performance.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIGS. 1A, 1B, 2, 3, 4A, 4B, and 5 show optically-readable electromagnetic antennas for electronic devices according to various embodiments;

FIG. 6 shows examples of optically-readable patterns according to various embodiments;

FIG. 7 is a block diagram of an RFID system according to various embodiments; and

FIG. 8 is a block diagram of a passive RFID tag according to various embodiments.

The attached drawings are for purposes of illustration and are not necessarily to scale.

### DETAILED DESCRIPTION OF THE INVENTION

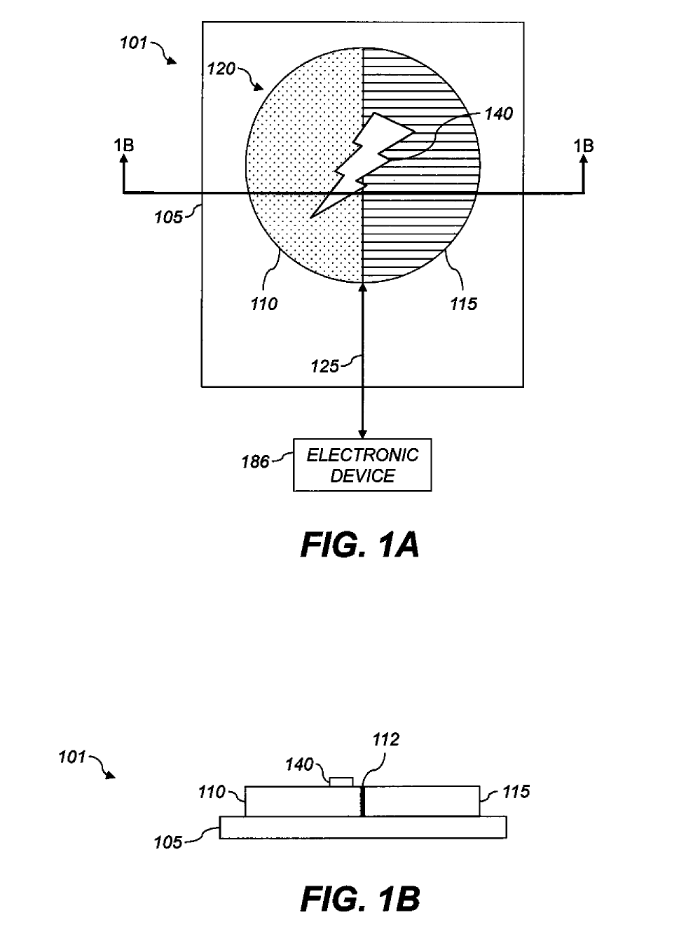

FIG. 1A shows an optically-readable electromagnetic antenna 101 for electronic device 186 according to various embodiments. Antenna 101 is an electromagnetic antenna, so it can transmit and receive electromagnetic radiation. Depending on the frequency, this radiation can be primarily electric-field, primarily magnetic-field (e.g., 13.56 MHz inductive coupling), or electromagnetic far-field (e.g., RF at 900 MHz). Antenna 101 is also optically-readable, meaning it conveys information in the optical band (e.g., 450-750 nm wavelength electromagnetic radiation).

Antenna 101 includes substrate 105 having a selected antenna region 120. Substrate 105 can be cardboard, paper, FR-4 or other fiberglass, plastic, or other non-conductive materials, or can be a conductive material overcoated with a non-conductor in antenna region 120. Substrate 105 can be a piece or sheet of paper, cardboard, or other planar or laminate media, glass, fabric, or metal, or another object. First conductive element 110 is disposed over substrate 105 in a first portion of antenna region 120, as shown. In this example, the first portion and first conductive element 110 overlap, so only element 110 is shown. Element 110 has a first color, as will be discussed further below. Element 110 conducts electricity so that it is operational as an electromagnetic antenna or portion thereof.

Antenna 101 also includes second conductive element 115 that has a second color different from the first color. Element 115 is disposed over the substrate in a second portion (not shown; overlaps element 115) of selected antenna region 120, as shown. The second portion abuts the first portion, so element 115 abuts element 1.10 and elements 110, 115 are electrically connected. (Electrical connection can be made through intervening circuit components.) As a result, elements 110, 115 function as a single electrical conductor of antenna 101. For example, antenna 101 can be a circular monopole antenna. Elements 110, 115 can overlap slightly, e.g., to provide for manufacturing process tolerances. In various embodiments, the first portion and second portion together cover the entire selected antenna region 120. Elements 110, 115 can be formed in various ways, as discussed below.

Feed line 125, which can be a via, trace, other conductor, or combination of any of these, electrically connects first element 110 or second element 115 to electronic device 186, so that antenna 101 can transmit signals from, and receive signals for, electronic device 186. Feed line 125 can extend out of the selected antenna region, as shown in this example. The RF properties of antenna 101 can be determined by the overall shape of selected antenna region 120, since elements 110 and 115 serve as a single electrical conductor.

The first and second portions together define an optically-readable pattern. An optically-readable pattern is perceptible in wavelengths below 1 μm, e.g., 400 nm-750 nm. The pattern is not required to be visible to unaided human vision. For example, the first color or the second color can be UV-fluorescent, or transparent (optical transmission >50% at the wavelengths of interest), or pigmented, or dyed, or IR-absorbent. An optically-readable pattern conveys information to a human observer, or to a computer programmed to read information from images (e.g., a barcode reader). The information can be in any form; the optically-readable pattern can include one or more logos, icons, symbols, text (e.g., warnings, general or product information, price, instructions), certification stamps or marks (e.g., TÜV, GSA, UL, NOM, CE, JIS), or pictograms. The optically-readable pattern can be a barcode or include a plurality of barcodes, as discussed below.

Electronic device 186 can include, for example, a CPU, MPU, ASIC, FPGA, PLD, PAL, PLA, or other digital logic device, and can include analog circuitry in addition to or instead of digital circuitry. Electronic device 186 transmits or receives electronic or electromagnetic signals through antenna 101. For example, electronic device 186 can be an RFID tag controller adapted to listen for interrogation signals from a reader and respond with a tag ID and, optionally, other stored data values. Electronic device 186 can include its own substrate or be deposited or built on substrate 105.

In various embodiments, antenna 101 includes marking pattern 140 disposed over the elements 110, 115 opposite substrate 105. In this example, marking pattern 140 is in the shape of a lightning-bolt symbol. Marking pattern 140 can be formed using ink, toner, or other marking materials. Marking pattern 140 can be formed directly on the elements 110, 115 or on transparent or partially transparent layers (not shown) formed over the elements 110, 115. Such transparent or partially transparent layers (for example, including resins) can provide physical or environmental protection to the elements 110, 115 and can be electrically insulating. Likewise, marking pattern 140 can include materials that provide physical or environmental protection to the elements 110, 115, and can be electrically insulating or include electrically-insulating materials. FIG. 1B shows a cross-section through antenna 101 along the line 1B-1B in FIG. 1A. As shown, substrate 105 supports elements 110, 115, which abut and electrically connect through (i.e., at one or more points of) interfacial surface 112. The visible portion of marking pattern 140 is disposed over element 110.

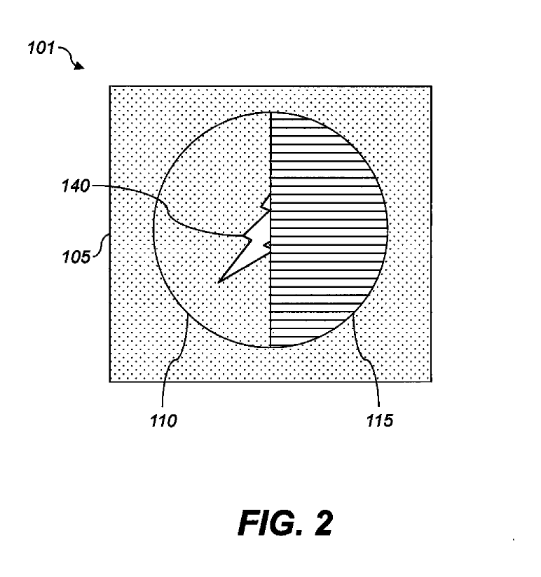

FIG. 2 shows an optically-readable electromagnetic antenna 101 for electronic device 186 (FIG. 1A) according to various embodiments. In some embodiments, substrate 105 is transparent, and marking pattern 140 is disposed between substrate 105 and element 110 or element 115.

In other embodiments, the first color (the color of element 110) is transparent. As used herein, “transparent color” describes a transparent material, as discussed above. In some of these embodiments, the second color (the color of element 115) is not transparent, such as shown here. Marking pattern 140 can be disposed between substrate 105 and first conductive element 110. In this example, marking pattern 140 is visible through transparent element 110, but is obscured by non-transparent element 115.

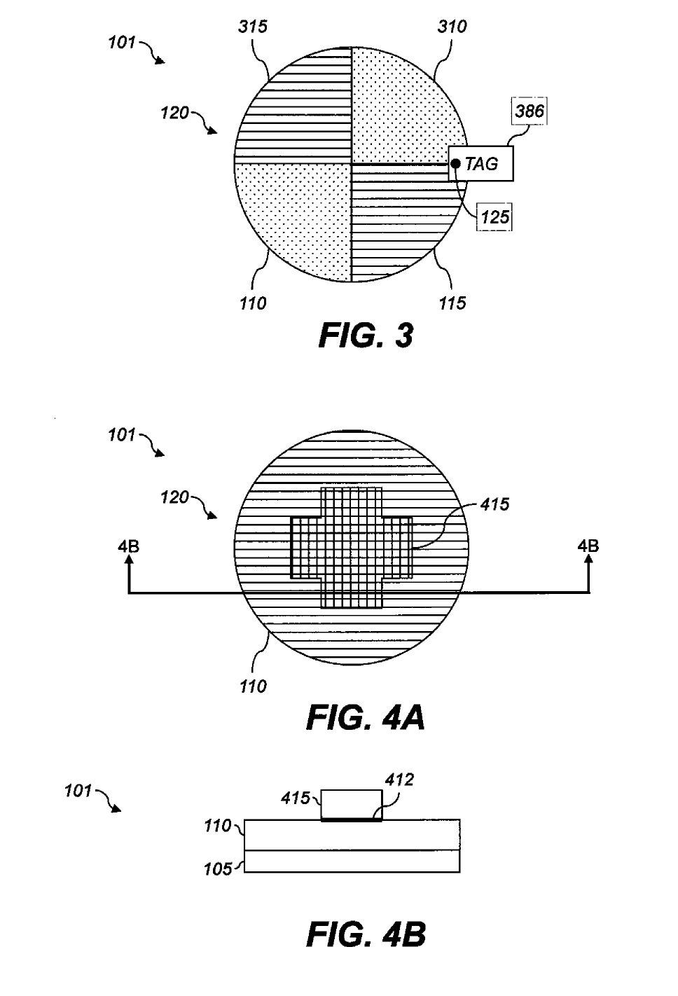

FIG. 3 shows an optically-readable electromagnetic antenna 101 for electronic device 186 (FIG. 1A) according to various embodiments. Antenna region 120 is as shown in FIG. 1A. First element 110 and second element 115 are as shown in FIG. 1A, but the respective first and second portions do not cover antenna region 120. Antenna 101 includes at least one additional, spaced-apart first conductive element 310. Each original and additional first conductive element (here, elements 110, 310) is electrically connected to second conductive element 115.

In some embodiments, antenna 101 includes at least one additional, spaced-apart second conductive element 315, each second element 115, 315 being electrically connected to one of the first conductive elements 110, 310. The antenna can include any number of conductive elements with respective portions that cover antenna region 120. All the conductive elements are electrically connected so that a single antenna in antenna region 120 is formed. A single electronic device 186 can be connected to multiple antennas 101 with respective selected antenna regions 120; those antennas can be interdigitated or otherwise adjacent to or surrounding each other.

In various embodiments, electronic device 386 is disposed over substrate 105 (FIG. 1A) at least partially within antenna region 120. Electronic device 386 can be disposed over or under any or all of the conductive elements 110, 115, 310, 315. Electronic device 386 can be disposed entirely over antenna region 120 or can protrude therefrom (as shown). In the example shown, feed line 125 is a via from electronic device 386 to elements 115, 310, and feed line 125 is located entirely within antenna region 120.

In various embodiments, electronic device 386 is a radio-frequency ID (RFID) tag coupled to feed line 125 of antenna 101. The RFID tag (device 386) is adapted to transmit an electromagnetic signal using antenna 101. The tag can transmit signals actively, by supplying current to antenna 101 through feed line 125. The tag can also backscatter signals by adjusting the impedance it presents to antenna 101. The tag can be connected to one or more other antennas (not shown). Antenna 101 can be shaped as a coil (e.g., for inductive systems), a patch, or another shape.

FIG. 4A shows an optically-readable electromagnetic antenna 101 for electronic device 186 (FIG. 1A) according to various embodiments. Antenna region 120 is as shown in FIG. 1A. First element 110 is as shown in FIG. 1A. Second element 415 is described above with reference to second element 115 (FIG. 1A), except that the second portion (element 415) at least partially overlaps the first portion (element 110) so that the first and second conductive elements 110, 415 are electrically connected. In the example shown, horizontal hatching indicates element 110 and vertical hatching indicates element 415. They overlap under element 415. The first and second portions together define an optically-readable pattern, as discussed above. In various embodiments, the overlap area between the first portion and the second portion is at least 2 mm². This can be larger than the overlap due to manufacturing tolerances. In various embodiments, the second portion overlaps the entire first portion. For example, the first portion can be shaped as a UPC code (discussed below), and the second portion can be a clearcoat over the first portion.

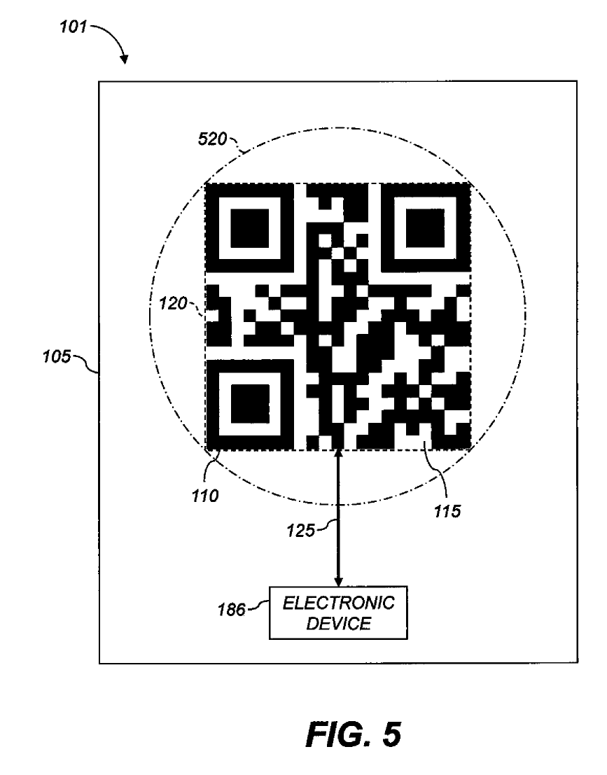

FIG. 4B shows a cross-section through antenna 101 along the line 4B-4B in FIG. 4A. As shown, substrate 105 supports elements 110. Element 415 is disposed over element 110 and electrically connects to it through interfacial surface 412. FIG. 5 shows an optically-readable electromagnetic antenna 101 for electronic device 186 (FIG. 1A) according to various embodiments. Antenna region 120, elements 110, 115, feed line 125, and electronic device 186 are as shown in FIG. 1A. Bounding ellipse 520 is formally the 2-D minimum volume area enclosing ellipsoid of antenna region 120, or the minimum-area enclosing ellipse, and can be calculated using the Khachiyan Algorithm. That is, no ellipse with smaller area than ellipse 520 will enclose antenna region 120. Further details are provided in N. Moshtagh, “Minimum volume enclosing ellipsoids,” GRASP Laboratory, University of Pennsylvania, incorporated herein by reference. In various embodiments, bounding ellipse 520 has eccentricity <0.1.

In this example, there are a plurality of first elements 110 (for clarity, only one is labeled). Elements 110 are the dark portions shown. There are a plurality of second elements 115 (for clarity, only one is labeled) that are the light portions shown. Elements 110 and 115 together form an optically-readable pattern, specifically a QR CODE, a type of two-dimensional (2-D) barcode (standardized by DENSO WAVE). In this and other embodiments, the optically-readable pattern encodes a first data stream. The first data stream can be a digital bit stream, as in this example. The optically-readable pattern can encode an analog or digital signal. The optically-readable pattern can also be a 1-D or 2-D barcode.

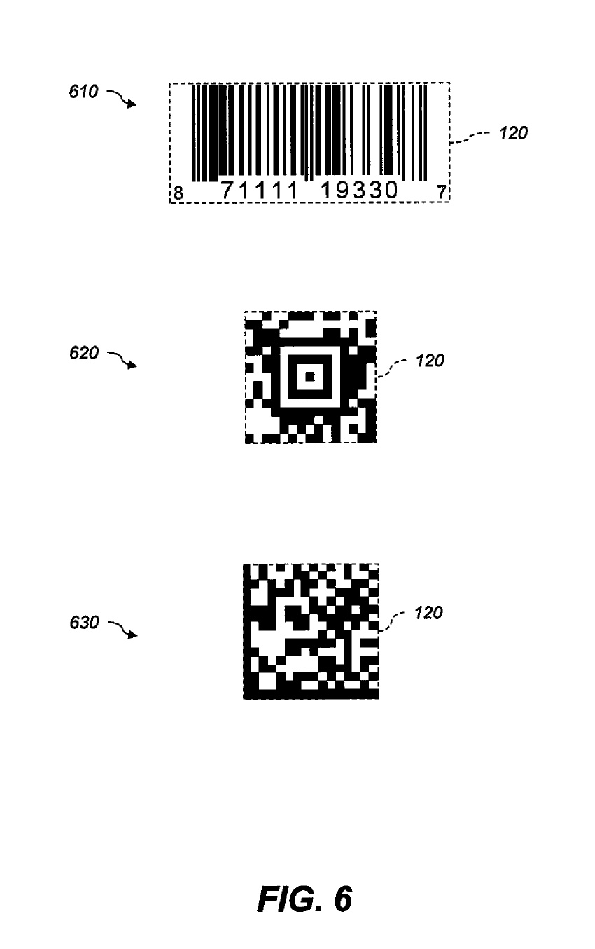

FIG. 6 shows examples of optically-readable patterns according to various embodiments. In each example, the corresponding antenna region 120 (described above with reference to FIG. 1A) is shown. UPC-A barcode 610 can encode eleven digits and a check digit (the rightmost “7”). Barcode 610 includes the barcode and non-barcode content (the digits). In general, antenna region 120 can include one or more barcode(s) and additional content. Aztec barcode 620 (per ISO/IEC 24778:2008 standard “Information technology—Automatic identification and data capture techniques—Aztec Code bar code symbology specification”) and Data Matrix barcode 630 (per ISO/IEC 16022 “Information technology—Automatic Identification and data capture techniques—Data Matrix”) can encode alphanumeric text, e.g., uniform resource locators (URLs). Other 1D, stacked-1D, and 2D barcode formats can be used, e.g., EAN, POSTNET, GS1 DATABAR, PDF417 (per ISO/IEC 15438:2006 “Information technology—Automatic identification and data capture techniques—PDF417 bar code symbology specification”), or MICROSOFT TAG.

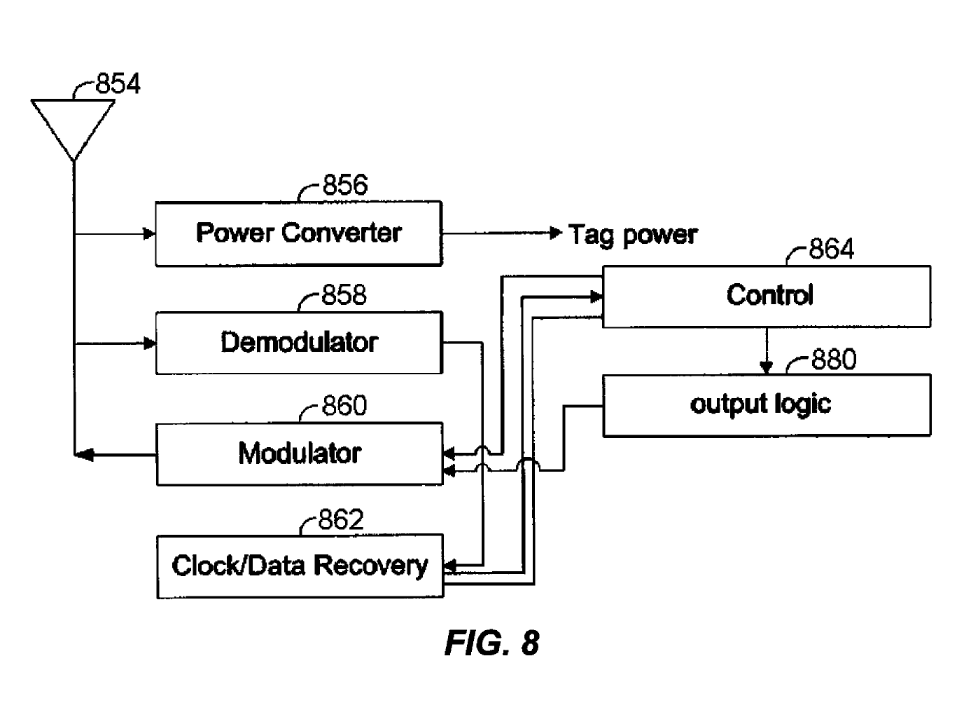

In various embodiments using an RFID tag (FIG. 3), the electromagnetic signal from the RFID tag can be an encoding of a second data stream different from the first data stream. The first and second data streams can also be the same. More details of the operation of RFID tags are discussed below with reference to FIGS. 8 and 9.

Referring back to FIG. 5, first element(s) 110 and second element(s) 115 can be formed by printing conductive inks, toners, or other substances on substrate 105. Such substances are referred to herein as “marking substances,” even if the mark is not visible to the unaided human eye (e.g., transparent conductor such as PEDOT). The conductivity and color of a given element 110, 115 can be adjusted by depositing multiple, different marking substances in appropriate concentrations in a selected region, or by mixing different marking substances in a desired proportion before depositing them. In an example, a copper-containing magenta marking substance is used with silver-containing cyan and yellow marking substances and a carbon-containing black marking substance to provide full-color CMYK printing capability in conductive elements 110, 115.

Marking substances can be deposited using thermal or piezoelectric inkjet (drop-on-demand or continuous), electrophotography, wax transfer, or other printing processes. Details of electrophotographic printers are provided in U.S. Pat. No. 6,608,641, issued on Aug. 19, 2003, to Peter S. Alexandrovich et al., in U.S. Pat. No. 7,502,582, issued Mar. 10, 2009 to Yee S. Ng et al., and in U.S. Ser. No. 12/942,420, filed Nov. 9, 2010, each of which is incorporated herein by reference. Details of inkjet printers are provided in U.S. Ser. No. 13/245,957, filed Sep. 27, 2011, incorporated herein by reference. Marking substances can also be deposited by vacuum deposition or spin-coating.

Printers are useful for producing printed images of a wide range of types. Printers print on receivers (or “imaging substrates”), such as paper or cardboard, for example as found in packaging material. Printers typically operate using subtractive color: a substantially reflective receiver is overcoated image-wise with cyan (C), magenta (M), yellow (Y), black (K), and other colorants. Various schemes can be used to process images to be printed.

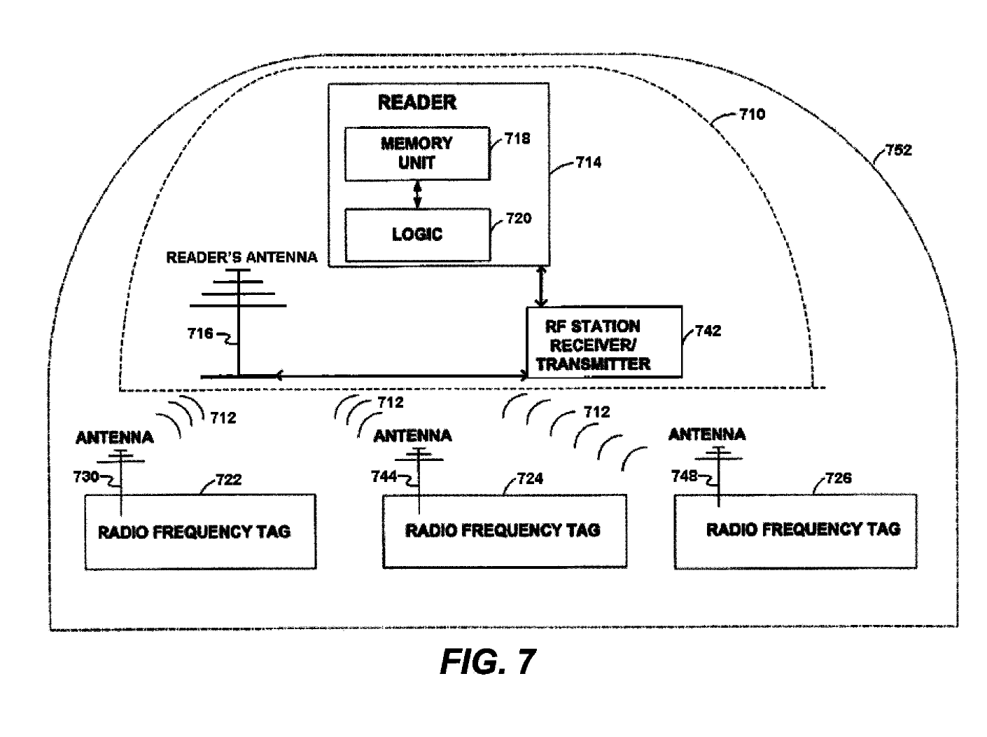

FIG. 7 is a block diagram of an RFID system according to various embodiments. Base station 710 communicates with three RF tags 722, 724, 726, which can be active or passive in any combination, via a wireless network across an air interface 712. FIG. 7 shows three tags, but any number can be used. Base station 710 includes reader 714, reader's antenna 716 and RF station 742. RF station 742 includes an RF transmitter and an RF receiver (not shown) to transmit and receive RF signals via reader's antenna 716 to or from RF tags 722, 724, 726. Tags 722, 724, 726 transmit and receive via respective antennas 730, 744, 748.

Reader 714 includes memory unit 718 and logic unit 720. Memory unit 718 can store application data and identification information (e.g., tag identification numbers) or SG TINs of RF tags in range 752 (RF signal range) of reader 714. Logic unit 720 can be a microprocessor, FPGA, PAL, PLA, or PLD. Logic unit 720 can control which commands that are sent from reader 714 to the tags in range 752, control sending and receiving of RF signals via RF station 742 and reader's antenna 716, or determine if a contention has occurred.

Reader 714 can continuously or selectively produce an RF signal when active. The RF signal power transmitted and the geometry of reader's antenna 716 define the shape, size, and orientation of range 752. Reader 714 can use more than one antenna to extend or shape range 752.

RFID standards exist for different frequency bands, e.g., 125 kHz (LF, inductive or magnetic-field coupling in the near field), 13.56 MHz (HF, inductive coupling), 433 MHz, 860-960 MHz (UHF, e.g., 915 MHz, RF coupling beyond the near field), or 2.4 GHz. Tags can use inductive, capacitive, or RF coupling (e.g., backscatter) to communicate with readers.

Radio frequency identification systems are typically categorized as either “active” or “passive.” In an active RFID system, tags are powered by an internal battery, and data written into active tags can be rewritten and modified. In a passive RFID system, tags operate without an internal power source and are typically programmed with a unique set of data that cannot be modified. A typical passive RFID system includes a reader and a plurality of passive tags. The tags respond with stored information to coded RF signals that are typically sent from the reader. Further details of RFID systems are given in commonly-assigned U.S. Pat. No. 7,969,286 to Adelbert, and in U.S. Pat. No. 6,725,014 to Voegele, both of which are incorporated herein by reference.

In a commercial or industrial setting, tags can be used to identify containers of products used in various processes. A container with a tag affixed thereto is referred to herein as a “tagged container.” Tags on containers can carry information about the type of products in those containers and the source of those products. For example, as described in the GS1 EPC Tag Data Standard ver. 1.6, ratified Sep. 9, 2011, incorporated herein by reference, a tag can carry a “Serialized Global Trade Item Number” (SGTIN). Each SGTIN uniquely identifies a particular instance of a trade item, such as a specific manufactured item. For example, a manufacturer of cast-iron skillets can have, as a “product” (in GS1 terms) a 10″ skillet. Each 10″ skillet manufactured has the same UPC code, called a “Global Trade Item Number” (GTIN). Each 10″ skillet the manufacturer produces is an “instance” of the product, in GS1 terms, and has a unique Serialized GTIN (SGTIN). The SGTIN identifies the company that makes the product and the product itself (together, the GTIN), and the serial number of the instance. Each box in which a 10″ skillet is packed can have affixed thereto an RFID tag bearing the SGTIN of the particular skillet packed in that box. SGTINs and related identifiers, carried on RFID tags, can permit verifying that the correct products are used at various points in a process.

FIG. 8 is a block diagram of a passive RFID tag (e.g., tags 722, 724, 726 shown in FIG. 7) according to various embodiments. The tag can be a low-power integrated circuit, and can employ a “coil-on-chip” antenna for receiving power and data. The RFID tag includes antenna 854 (or multiple antennas), power converter 856, demodulator 858, modulator 860, clock/data recovery circuit 862, control unit 864, and output logic 880. Antenna 854 can be an omnidirectional antenna impedance-matched to the transmission frequency of reader 714 (FIG. 7). The RFID tag can include a support, for example, a piece of polyimide (e.g., KAPTON) with pressure-sensitive adhesive thereon for affixing to packages. The tag can also include a memory (often RAM in active tags or ROM in passive tags) to record digital data, e.g., an SGTIN.

Reader 714 (FIG. 7) charges the tag by transmitting a charging signal, e.g., a 915 MHz sine wave. When the tag receives the charging signal, power converter 856 stores at least some of the energy being received by antenna 854 in a capacitor, or otherwise stores energy to power the tag during operation.

After charging, reader 714 transmits an instruction signal by modulating onto the carrier signal data for the instruction signal, e.g., to command the tag to reply with a stored SGTIN. Demodulator 858 receives the modulated carrier bearing those instruction signals. Control unit 864 receives instructions from demodulator 858 via clock/data recovery circuit 862, which can derive a clock signal from the received carrier. Control unit 864 determines data to be transmitted to reader 714 and provides it to output logic 880. For example, control unit 864 can retrieve information from a laser-programmable or fusible-link register on the tag. Output logic 880 shifts out the data to be transmitted via modulator 860 to antenna 854. The tag can also include a cryptographic module (not shown). The cryptographic module can calculate secure hashes (e.g., SHA-1) of data or encrypt or decrypt data using public- or private-key encryption. The cryptographic module can also perform the tag side of a Diffie-Hellman or other key exchange.

Signals with various functions can be transmitted; some examples are given in this paragraph. Read signals cause the tag to respond with stored data, e.g., an SGTIN. Command signals cause the tag to perform a specified function (e.g., kill). Authorization signals carry information used to establish that the reader and tag are permitted to communicate with each other.

Passive tags typically transmit data by backscatter modulation to send data to the reader. This is similar to a radar system. Reader 714 continuously produces the RF carrier sine wave. When a tag enters the reader's RF range 752 (FIG. 7; also referred to as a “field of view”) and receives, through its antenna from the carrier signal, sufficient energy to operate, output logic 880 receives data, as discussed above, which is to be backscattered.

Modulator 860 then changes the load impedance seen by the tag's antenna in a time sequence corresponding to the data from output logic 880. Impedance mismatches between the tag antenna and its load (the tag circuitry) cause reflections, which result in momentary fluctuations in the amplitude or phase of the carrier wave bouncing back to reader 714. Reader 714 senses occurrences and timing of these fluctuations and decodes them to receive the data clocked out by the tag. In various embodiments, modulator 860 includes an output transistor (not shown) that short-circuits the antenna in the time sequence (e.g., short-circuited for a 1 bit, not short-circuited for a 0 bit), or opens or closes the circuit from the antenna to the on-tag load in the time sequence. In another embodiment, modulator 860 connects and disconnects a load capacitor across the antenna in the time sequence. Further details of passive tags and backscatter modulation are provided in U.S. Pat. No. 7,965,189 to Shanks et al. and in “Remotely Powered Addressable UHF RFID Integrated System” by Curty et al., IEEE Journal of Solid-State Circuits, vol. 40, no. 11, November 2005, both of which are incorporated herein by reference. As used herein, both backscatter modulation and active transmissions are considered to be transmissions from the RFID tag. In active transmissions, the RFID tag produces and modulates a transmission carrier signal at the same wavelength or at a different wavelength from the read signals from the reader.

Referring back to FIG. 1A, in various embodiments, antenna 101 is printed onto substrate 105. Respective differently colored conductive inks are used to form elements 110, 115. The colors and arrangement of the conductive inks form optically readable information in selected antenna region 120. Electronic device 186 is a radio-frequency communication device having coded information that is affixed to substrate 105 and electrically connected to antenna 101. Substrate 105 is part of a package for an instance of a product (defined above), or of a package for several instances (e.g., a carton). Substrate 105 can be the cardboard that forms a cardboard box. Antenna 101 and electronic device 186 can be applied to substrate 105 by a single operation or time-separated operations. Either can be applied to substrate 105 before or after substrate 105 is formed into its package configuration (e.g., folded into shape).

In various embodiments, the coded information in electronic device 186 is an identification of the product or the instance. The optically readable information also identifies the product (e.g., a UPC code) or the instance (e.g., a GS1 DATAMATRIX barcode carrying an SGTIN). The package, including the instance, electronic device 186, and antenna 101, is transported successively to a variety of locations (e.g., transshipment points or wholesaler or retailer facilities). At some of the locations, RFID readers can read the coded information by sending electro-magnetic signals through antenna 101 to interrogate electronic device 186. At other locations, the optically readable antenna is optically read to receive identification information. At both types of locations, the received information is used to determine package routing to further locations, for example from a factory to a retail establishment. The optically readable information can be read by machine (e.g., a barcode reader) or by a person.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### Parts List

101 antenna
105 substrate
110, 115 conductive element
112 interfacial surface
120 antenna region
125 feed line
140 marking pattern
186 electronic device
310, 315 conductive element
386 RFID tag
412 interfacial surface
415 conductive element
520 bounding ellipse
610 UPC-A barcode
620 Aztec barcode
630 Data Matrix barcode
710 base station
712 air interface
714 reader
716 reader's antenna
718 memory unit
720 logic unit
722, 724, 726 RFID tag
730 antenna
742 RF station
744, 748 antenna
752 range
854 antenna
856 power converter
858 demodulator

### Parts List—Continued

860 modulator
862 clock/data recovery circuit
864 control unit
880 output logic

1. Optically-readable electromagnetic antenna for an electronic device, the antenna comprising:
a) a substrate having a selected antenna region;
b) a first conductive element having a first color disposed over the substrate in a first portion of the selected antenna region;
c) a second conductive element having a second color different from the first color and disposed over the substrate in a second portion of the selected antenna region, the second portion abutting the first portion so that the first and the second conductive elements are electrically connected; and
d) a feed line electrically connecting the first or the second conductive element to the electronic device;
e) wherein the first and the second portions together define an optically-readable pattern.

2. The antenna according to claim 1, further including a marking pattern disposed over the first or the second conductive elements opposite the substrate.

3. The antenna according to claim 1, wherein the substrate is transparent, further including a marking pattern disposed between the substrate and the first or the second conductive elements.

4. The antenna according to claim 1, wherein the first color is transparent.

5. The antenna according to claim 4, wherein the second color is not transparent.

6. The antenna according to claim 4, further including a marking pattern disposed between the substrate and the first conductive element.

7. The antenna according to claim 1, further including at least one additional, spaced-apart first conductive element, each additional first conductive element being electrically connected to the second conductive element.

8. The antenna according to claim 7, further including at least one additional, spaced-apart second conductive element, each additional second conductive element being electrically connected to the first conductive element or at least one of the additional first conductive elements.

9. The antenna according to claim 1, wherein the feed line extends out of the selected antenna region.

10. The antenna according to claim 1, wherein the electronic device is disposed over the substrate at least partially within the selected antenna region.

11. The antenna according to claim 1, wherein the selected antenna region has a bounding ellipse with eccentricity <0.1.

12. The antenna according to claim 1, wherein the first color or the second color is UV-fluorescent, or transparent, or pigmented, or dyed, or IR-absorbent.

13. The antenna according to claim 1, wherein the optically-readable pattern encodes a first data stream.

14. The antenna according to claim 13, wherein the data stream is an encoding of a digital bit stream.

15. The antenna according to claim 13, wherein the optically-readable pattern is a barcode.

16. The antenna according to claim 1, wherein the first portion and the second portion together cover the entire antenna region.

17. A radio-frequency identification (RFID) system, comprising:
a) an antenna according to claim 1, wherein the optically-readable pattern encodes a first data stream; and
b) an RFID tag coupled to the feed line of the antenna, the RFID tag adapted to transmit an electromagnetic signal using the antenna.

18. The system according to claim 17, wherein the electromagnetic signal is an encoding of a second data stream different from the first data stream.

19. Optically-readable electromagnetic antenna for an electronic device, the antenna comprising:
a) a substrate having a selected antenna region;
b) a first conductive element having a first color disposed over the substrate in a first portion of the selected antenna region;
c) a second conductive element having a second color different from the first color and disposed over the substrate in a second portion of the selected antenna region, the second portion at least partially overlapping the first portion so that the first and the second conductive elements are electrically connected; and
d) a feed line electrically connecting the first or the second conductive element to the electronic device;
e) wherein the first and the second portions together define an optically-readable pattern.

20. The antenna according to claim 18, wherein an overlap area between the first portion and the second portion is at least 2 mm².

21. The antenna according to claim 18, wherein the second portion overlaps the entire first portion.
